(19) United States
(12) Patent Application Publication
(10) Pub. No.: US 2024/0396154 A1
(43) Pub. Date: Nov. 28, 2024

(54) Venting Unit for Battery Pack and Battery Pack Including Same

(71) Applicant: SAMSUNG SDI CO., LTD., Yongin-si (KR)

(72) Inventor: Paul KRAUS, Graz (AT)

(21) Appl. No.: 18/656,452

(22) Filed: May 6, 2024

Related U.S. Application Data
(60) Provisional application No. 63/504,344, filed on May 25, 2023.

(30) Foreign Application Priority Data
Apr. 3, 2024 (EP) 24168231.9

(51) Int. Cl. H01M 50/333

(52) U.S. Cl. CPC H01M 50/333

(57) ABSTRACT

A venting unit for a battery pack includes: a housing having a valve opening and a sealing lip around the valve opening; a first valve part; a stem, one end connected to the first valve part, an opposing end connected to a second valve part; and a spring between the housing and the second valve part. The first valve part has an opening portion with a planar part and a sloped part connected between the planar part and the stem. A gradient of the sloped part increases from the planar part toward the stem. In a closed state, the planar part of the opening portion and the sealing lip of the housing together seal a gap between the opening portion and the housing, and in an open state, the opening portion is spaced apart from the sealing lip against the spring.

### CROSS-REFERENCE TO RELATED APPLICATION

The present application claims priority to and the benefit of U.S. Provisional Patent Application Ser. No. 63/504,344, filed on May 25, 2023, in the United States Patent and Trademark Office and European Patent Application No. 24168231.9, filed on Apr. 3, 2024, in the European Union Intellectual Property Office, the entire contents of both of which are incorporated herein by reference.

### BACKGROUND

### 1. Field

Aspects of embodiments of the present disclosure relate to a venting unit for a battery pack and a battery pack including the venting unit.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for the movement of ions during charging and discharging of the battery cell. The electrode assembly is located in (or is accommodated in) a casing and electrode terminals, which are positioned on the outside of the casing, establish an electrically conductive connection to the electrodes. The shape of the casing may be, for example, cylindrical or rectangular.

A battery module is formed of (or includes) a plurality of battery cells connected together in series or in parallel. For example, the battery module is formed by interconnecting the electrode terminals of the plurality of battery cells in a number and/or configuration depending on a desired amount of power and to realize a high-power rechargeable battery.

Battery modules can be constructed in either a block design or in a modular design. In the block design, each battery cell is coupled to a common current collector structure and a common battery management system, and the unit thereof is arranged in a battery casing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, and respectively the battery cells, may be configured in a series, parallel, or a mixture of series and parallel connections to provide the desired voltage, capacity, and/or power density. Components of a battery pack include the individual battery modules and interconnects, which provide electrical conductivity between the battery modules.

A battery system may also include a battery management system (BMS), which is any suitable electronic system that is configured to manage the rechargeable battery cell(s), battery module(s), and battery pack, such as by protecting the batteries from operating outside their safe operating area, monitoring their states, calculating secondary data, reporting that data, controlling its environment, authenticating it, and/or balancing it. For example, the BMS may monitor the state of the battery cell as represented by voltage (e.g., a total voltage of the battery pack or battery modules and/or voltages of individual battery cells), temperature (e.g., an average temperature of the battery pack or battery modules, coolant intake temperature, coolant output temperature, or temperatures of individual battery cells), coolant flow (e.g., flow rate and/or cooling liquid pressure), and current. Additionally, the BMS may calculate values based on the above characteristics or measured values, such as minimum and maximum cell voltage, state of charge (SOC) or depth of discharge (DOD) to indicate the charge level of the battery cell, state of health (SOH; a variously-defined measurement of the remaining capacity of the battery cell as a percent of the original capacity), state of power (SOP; the amount of power available for a defined time interval given the current power usage, temperature, and other conditions), state of safety (SOS), maximum charge current as a charge current limit (CCL), maximum discharge current as a discharge current limit (DCL), and internal impedance of a cell (to determine open circuit voltage).

The BMS may protect the battery pack from operating outside its safe operating area, which may be indicated by over-current, over-voltage (e.g., during charging), over-temperature, under-temperature, over-pressure, and isolation fault or leakage current detection. The BMS may prevent the battery from operating outside its safe operating parameter by including an internal switch (e.g., a relay or solid-state device) that opens if the battery is operated outside its safe operating parameters, by requesting the devices to which the battery is connected to reduce or even terminate using the battery, and by actively controlling the environment, such as through heaters, fans, air conditioning, or liquid cooling.

An example of an operation condition outside the safe operating area is a thermal runaway of a battery cell that may occur due to, for example, contamination due to residual particles from production and may result in overheating or overcharging the battery cell. Thermal runaway is a self-accelerating chemical reaction inside the battery cell, which produces large amounts of heat and gas. In a thermal runaway situation, the battery cell temperature rises quickly.

The BMS is critical to the safe operation and optimal performance of rechargeable battery cells and helps to reduce and minimize the possibility of thermal runaway. For example, if the BMS detects that the temperature is too high, it can regulate the temperature by controlling cooling fans. If the battery cell cannot be sufficiently cooled and safe conditions cannot be restored, the BMS may shut down battery cells as necessary to protect the system.

### SUMMARY

According to embodiments of the present disclosure, an improved valve for a battery casing of a battery pack is provided as well as a battery pack including the valve.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a venting unit for a battery pack includes a valve assembly, the valve assembly includes: a housing having a valve opening and a sealing lip extending around the valve opening; a first valve part configured to open and close the valve opening; a second valve part; a stem connected, at one end, to the first valve part and connected, at an opposite end, to the second valve part; and a spring extending along the stem between the housing and the second valve part. The first valve part has an opening portion with a planar part and a sloped part connected, at one side, to the planar part and connected, at an opposing side, to the stem. A gradient of the sloped part increases from the planar part toward the stem. In a closed state of the valve assembly, the planar part of the first valve part opening portion and the sealing lip of the housing are on top of each other to seal a gap between the opening portion and the housing, and in an open state of the valve assembly, the opening portion is spaced apart from the sealing lip against the force of the spring such that a release gap is formed between the sloped part of the opening portion and the sealing lip.

The venting unit may further include a cover cap covering the valve assembly, and the cover cap may have a cover cap opening directed in (or facing) a first direction.

The stem and the spring may extend perpendicularly to the first valve part and the second valve part.

The first valve part may have a guide rib on its inner surface portion. The guide rib and the sealing lip may remain in close contact during opening of the valve assembly.

The gradient of the sloped part may have its smallest value at a connection point between the sloped part and the planar part.

The first valve part may be movable along a longitudinal direction of the stem between an opened end position and a closed end position.

During opening of the valve assembly, the release gap between the sealing lip and the sloped part increases, and a maximum size of the release gap may be equal to a distance between the sealing lip and the stem.

The spring may be in a pretensioned state.

The stem may be hollow.

The sealing lip for contacting the planar part of the first valve part is raised with respect to its surrounding housing surface.

According to an embodiment of the present disclosure, a battery pack includes a plurality of battery cells accommodated within a battery casing and a venting unit as described above. The battery casing may have a venting unit mounted to a venting hole in the battery casing.

A guide rib may have a guide surface configured to move parallel to the longitudinal direction of the stem.

The stem of the valve assembly may protrude into an interior of the battery casing perpendicular to the battery casing.

According to another embodiment of the battery pack, a plurality of venting units may be mounted to respective venting holes in the battery casing.

According to another embodiment of the battery pack including a venting unit as described above, a cover cap opening may point in (or may face) the direction of gravity.

According to another embodiment of the present disclosure, an electric vehicle including the battery pack as described above is provided.

Additional aspects and features of the present disclosure, and additional embodiments of the present disclosure, will be described in detail below.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1A is a schematic cross-sectional side view of a venting unit according to an embodiment in a closed state;

FIG. 1B is a schematic cross-sectional side view of the venting unit shown in FIG. 1A in an open state;

FIG. 1C is a detailed schematic cross-sectional side view of the venting unit as shown in FIG. 1A;

FIG. 1D is a schematic cross-sectional side view of the venting unit as shown in FIG. 1A;

FIG. 2 is a schematic perspective exploded view of the venting unit shown in FIG. 1A;

FIG. 3A is a schematic perspective view of the venting unit shown in FIG. 1A.

FIG. 3B is a schematic perspective view of the venting unit shown in FIG. 1A without a cover cap;

FIG. 4 is a graph describing a flow area in relation to compression of a spring of the venting unit;

FIG. 5A is a plotted function describing a shape of a sloped part of a venting unit;

FIG. 5B is a plotted function describing a shape of a sloped part of a venting unit according to another embodiment;

FIG. 6A is a schematic cross-sectional side view of a battery pack including a venting unit according to an embodiment;

FIG. 6B is a schematic cross-sectional side view of an electric vehicle including a battery pack according to an embodiment;

FIG. 7 is a flow chart describing a method for assembling a venting unit according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a venting unit for a battery pack includes at least a valve assembly. The valve assembly includes a housing having a valve opening and a sealing lip formed around the valve opening. The valve opening may be round, rectangular, or may have any other suitable shape. The valve assembly further includes a first valve part (e.g., a first valve) configured to open and close the valve opening, a stem connected to the first valve part at one of its ends, the opposing end of the stem having a second valve part (e.g., a second valve) and a spring extending along the stem between the housing and the second valve part. The first valve part includes an opening portion having a planar part, and a sloped part. The sloped part is on one side connected to the planar part and on the opposing side connected to the stem. A gradient of the sloped part increases from the planar part towards the stem. The gradient of the sloped part decreases from the planar part towards the stem. In a closed state of the valve assembly, the planar part of the opening portion and the sealing lip of the housing are on top of each other to seal a gap between them. In an open state of the valve assembly, the opening portion is configured to move away from the sealing lip against the force of the spring such that a release gap is formed between the opening portion and the sealing lip.

The venting unit may avoid overpressure due to, for example, hot gas that is released during a thermal runaway of battery cells within the battery pack. To control the opening behavior of the venting unit, a valve pretensioned by a spring is used. If the pressure within the battery packs rises, the pressure on the movable valve-body rises as well and acts as an internal force onto the valve body. When the force is larger than the force of the spring closing the valve, the valve opens and establishes a connection between both sides of the valve through which gas can flow.

During this disclosure, the planar part may not be entirely straight, but may include other structures like a sealing lip fixing means for fixing a sealing lip. The planar part may extend radially away from the valve opening. The sloped part may be continuously differentiable. The gradient refers to the state in which the valve opening is in a vertical position. Obviously, the relation of the gradient would be opposite when the valve opening is in a horizontal position. The release gap lies in a plane of the valve opening or parallel thereto.

Due to the increasing gradient of the sloped part, the flow area for air or hot gas does not increase linear with the opening of the valve. Further, a significant geometrical advantage can be obtained by moving the spring mechanism to the inside of the battery pack.

According to another embodiment of the present disclosure, the venting unit further includes a cover cap covering the valve assembly. The cover cap may be a protection cap, which protects the valve assembly from contaminations like dust and/or environmental influences like moisture and ice. Further, the cover cap is provided with at least one cover cap opening directed into a first direction. The cover cap opening may be directed such that the first direction is the direction of gravity.

In summary, the cover cap not only protects the valve assembly from direct damage due to physical contact, but also provides protection from environmental influences and contaminations. In this regard, the at least one cover cap opening which is directed into a first direction may be used to control the direction, to which the valve opens. This direction may be the direction of gravity, such that the environmental influences and contaminations would have to act against gravity. Thereby, the environmental influences and contaminations are reduced naturally. However, in special circumstances, for example in tight installation spaces, other directions may be beneficial in order to optimize certain design parameters like thermal parameters and safety parameters.

According to a further embodiment of the venting unit, the stem and the spring extend perpendicular to the first valve part and the second valve part.

The spring provides the counter-force for actuating the venting unit, that is, holding the valve unit in the normally closed state. In order to actuate the venting unit, a force acts on the first valve part and forces the valve into the open state, against the force of the spring. For the spring to act efficiently, the spring extends along the stem and is installed perpendicular to the first valve part and the second valve part.

According to another embodiment of the venting unit, the first valve part is provided with at least one guide rib on its inner surface portion. A guide rib may be a thin protruding portion connecting the stem and the first valve part. The connection may be such that the rigidity of the first valve part is increased. Thin may mean a thickness of between 0.5 to 3 mm. Optionally, the thickness may be in a range of 1 to 2 mm. Alternatively, the guide rib may only be present at the first valve part, that is not extend to the stem. Further alternatively, the guide rib may only be present at the outer circumference of the first valve part. The number of guide ribs may be two or more, three, four, five, or more. The at least one guide rib prevents a displacement of the first valve part in a direction other than the opening and closing direction of the valve assembly. In other words, the guide rib prevents a movement of the first valve part out of the valve opening. The guide rib may be provided such that the guide rib and the sealing lip remain in contact during opening of the valve assembly. Contact may mean that the guide rib is in direct contact with the sealing lip on at least one point such that the opening of the valve is guided by the contact between the guide rib and the sealing lip. The contact of the guide rib is made through a guide surface. The guide surface is provided radially extending from a guide rib body. Radial refers to the center or midpoint of the valve opening.

Thereby, the first valve part is held inside the valve opening in the open state of the valve assembly. The length of the guide surface may be equal to a length of the stem.

According to another embodiment of the venting unit, the gradient of the sloped part has its smallest value at the connection point of the sloped part to the planar part. As mentioned above, this refers to the state when the valve opening extends vertically. For the calculation of the gradient, the point where the planar part transitions into the sloped part may be excluded.

In one embodiment, the shape of the sloped part is defined by a non-linear function, wherein the origin is the transition point. Optionally, the non-linear function is polynomial or exponential. By the use of mathematical functions, the repeatability and design variables are easy to determine and apply.

This small gradient has the effect that initially, only a small release gap is available for gas on the inside to be released to the outside. This brings about the advantageous effect that even though the movement of the first valve part remains linear, the gas release is controlled to increase slowly first and increase more and more, the further the valve opens. The gradient increases monotonically. In other words, the release of air may follow a non-linear function, for example a polynomial or exponential curve, which may be defined by the gradient of the sloped part.

According to another embodiment of the venting unit, the first valve part is movable along a longitudinal direction L of the stem between an opened end position and a closed end position. The closed end position is in the closed state, when the sealing lip and the planar part seal the gap. The opened end position is reached when the spring is compressed completely or when any other physical limitation prevents a further opening of the first valve part. The distance between the opened end position and the closed end position is the first valve part travel distance. The first valve part travel distance may be identical to the compression of the spring starting from the closed state of the valve assembly.

According to another embodiment of the venting unit, the release gap between the sealing lip and the sloped part increases during opening of the valve assembly and the maximum of the release gap is equal to the distance between the sealing lip and the stem. The distance may be equal to the radially inner edge of the sealing lip and the radially outer wall of the stem, when the stem has reached at least the plane of the valve opening. The release gap may be formed in a plane of the valve opening and may be formed around and perpendicular to the stem.

As mentioned above, even though the movement of the spring and the first valve part is linear and proportional to a force acting onto the first valve part, the maximum of the release gap is not reached linearly, but for example exponentially, defined by the gradient of the sloped part.

According to another embodiment of the venting unit, the spring is in a pretensioned/prestressed/preloaded state in a closed state of the valve assembly. Pretensioned or prestressed or preloaded means that the spring is not in a relaxed state, but compressed. This compression may be minimal or even close to zero. Depending on the application, the pretension may be made larger, for example compliant with safety regulations. The pretension may provide tightness during normal operation. The pretension may consider the installation location such that a spring of a horizontally installed valve assembly acts against gravity and a vertically installed spring of a valve assembly does not act against gravity.

According to an optional embodiment of the venting unit, the stem is hollow.

A hollow stem is light and rigid and thus, provides a good performance for the valve assembly. Optionally, the wall of the stem may be provided with additional holes through its side wall. However, the stem is not limited thereto and may also be solid or have any other shape having the same functionality.

According to an optional embodiment of the venting unit, the sealing lip for contacting with the planar part of the first valve part is elevated with respect to its surrounding housing surface.

The sealing lip may be elastic. When the spring is pretensioned, the sealing lip is pressed against the planar part. Due to the elasticity, the sealing lip and the planar part may slightly deform but and their connection remains tight. Deformation may relate to a situation in which the sealing lip may tilt towards the center of the valve opening.

According to another embodiment of the venting unit, the first valve part is, at its face facing away from the housing, indented and forms a trough. Indented means that the middle portion of the first valve part is recessed. The recess may extend from one side of the housing to another side of the housing. The trough provides elasticity for the first valve part. Further, the air circulation within the installed cover cap is improved.

According to another embodiment of the venting unit, the valve opening is a void.

Thereby, airflow is not hindered in an open state of the valve assembly. Thus, the need for supporting webs within the valve opening of the housing is eliminated and air can freely flow through the valve opening.

According to a second aspect of the present disclosure, a battery pack includes a plurality of battery cells accommodated within a battery casing and at least one venting unit according to the first aspect. The battery casing is provided with the at least one venting unit mounted to a respective venting hole formed at the battery casing.

The guide rib includes a guide surface configured to move parallel to the longitudinal direction of the stem.

The stem of the valve assembly protrudes into an interior of the battery casing perpendicular to the battery casing. Perpendicular refers to the wall of the battery casing, to which the venting unit is installed to.

When the stem and the spring protrude to the interior of the battery pack, the outside of the battery back is flat. Thereby, the battery pack may be installed and handled more conveniently. Further, damage to the venting unit, for example during handling of the battery pack, is less likely.

According to another embodiment of the battery pack, at least two venting units are mounted to respective venting holes formed in the battery casing.

Due to the structure of the first valve part having the above-described gradient, when several valves are installed, tolerances can be compensated for and all valves open at the same time. Thereby, gas can be released uniformly through a plurality of venting unit installed to the battery pack. The tolerances may be spring tolerances or production tolerances of the housing and/or the first valve part.

According to another embodiment, the battery pack includes a venting unit according to the first aspect comprising a cover cap, wherein one or more cover cap openings point to the direction of gravity.

Thereby, the outer surface of the one or more venting units of the battery pack are largely guarded from contaminations like dust and environmental influences like moisture and ice, compared to a state where no cover cap is provided and where the cover cap openings are open to other directions except the direction of gravity. Due to the limitation of the one or more cover cap openings to the direction of gravity, the contaminations and environmental influences are hindered. It becomes much less likely that they reach the outer surface of the valve assembly and possibly block or disturb the action of the valve assembly. Consequently, the safety of the battery pack is improved.

According to a third aspect of the present disclosure, an electric vehicle includes the battery pack according to the second aspect.

Yet another aspect of the present disclosure refers to a method for assembling a venting unit according to the first aspect, including the following steps. Firstly, the first valve part and the housing are placed in this order and upside down onto a first ultrasonic tool fixture. The first valve part includes the stem. Secondly, the spring and the second valve part are placed in this order onto the stem of the first valve part as prepared under firstly. Thirdly, a second ultrasonic tool fixture is applied to the second valve part as prepared under secondly, thereby welding the second valve part to the stem of the housing and pre-tensioning the spring. Alternatively, the stem may be integrally formed with the second valve part such that the stem is welded to the first valve part. Further alternatively, the first valve part, the second valve part and the stem are integrally formed and the housing is formed of two parts, which are glued or welded around the integral valve part.

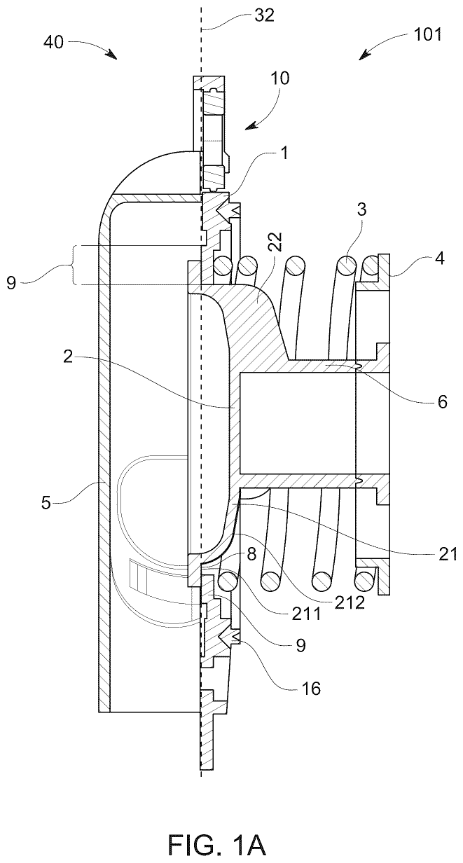

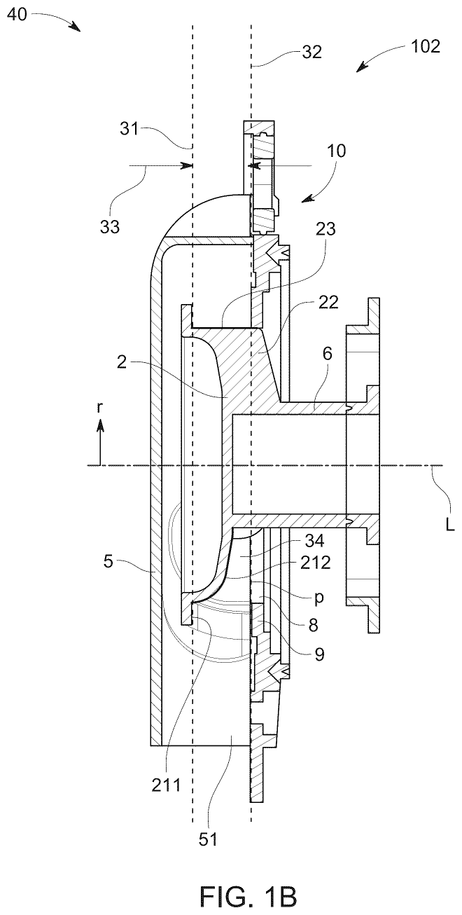

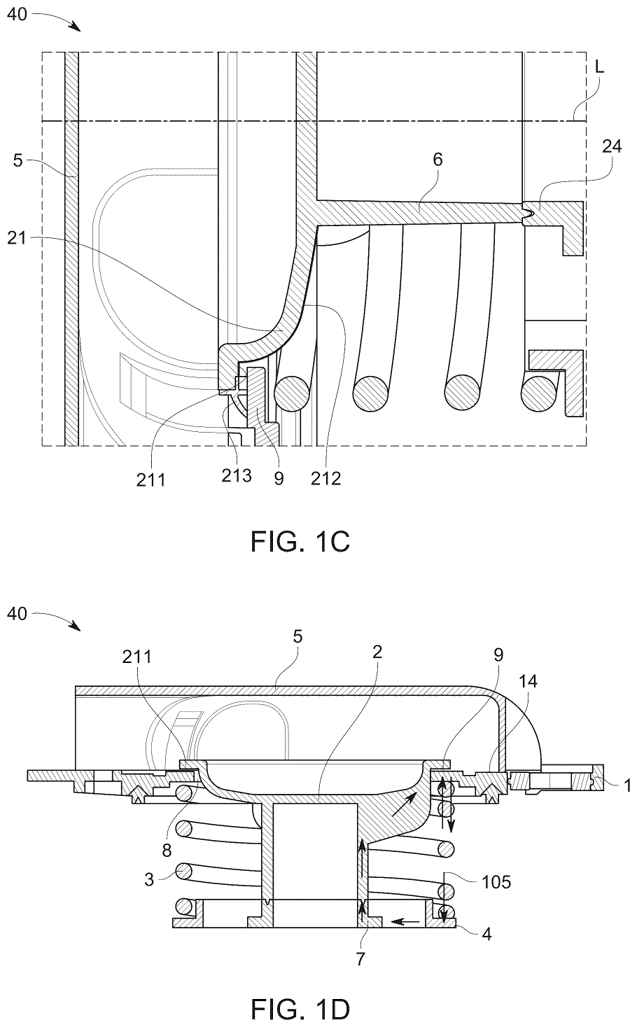

FIG. 1A is a schematic cross-sectional side view of a venting unit 40 in a closed state 101 according to an embodiment, FIG. 1B is a schematic cross-sectional side view of the venting unit 40 in an open state 102, and FIG. 1C is a detailed schematic cross-sectional side view of the venting unit 40 as shown in FIG. 1A. FIG. 1D is another schematic cross-sectional side view of the venting unit 40 in the closed state. For illustrative purposes, FIGS. 1A, 1B, 1C, and 1D will be described together, and parts or components designated by the same reference numerals may not be repeatedly described with respect to each of these figures. In the cross-sectional views of FIGS. 1A-1D, the structure of the venting unit 40 is visible. The venting unit 40 may be used in a battery pack, and the venting unit 40 includes a valve assembly 10 (see, e.g., FIG. 1A, under a cover cap 5) and, optionally, includes the cover cap 5. The valve assembly 10 includes a housing 1 with a valve opening 8 in which a first valve part 2 and a second valve part 4 are movably installed with respect to the housing 1 such that a pressure release gap 34 (see, e.g., FIG. 1B) is opened for venting. The valve assembly 10 further includes a sealing lip 9 formed around the valve opening 8, and the first valve part 2 is configured to open and close the valve opening 8. A stem 6 is connected to the first valve part 2 at one of its ends, a second valve part 4 is at the opposing end of the stem 6, and a spring 3 extends along the stem 6 between the housing 1 and the second valve part 4. The first valve part 2 has an opening portion 21 (shown as a thicker solid line in FIG. 1A) with a planar part 211 (see, e.g., FIG. 1C), and a sloped part 212 (see, e.g., FIG. 1C) connected, on one side, to the planar part 211 and connected, on the opposing side, to the stem 6. A gradient of the sloped part 212 increases from the planar part 211 towards the stem 6. In the closed state 101 of the valve assembly 10, the planar part 211 of the opening portion 21 and the sealing lip 9 are on top of each other to seal a gap between them. In the open state 102 of the valve assembly 10, the opening portion 21 spaced apart from (e.g., is configured to move away from) the sealing lip 9 against the force of the spring 3 such that a pressure release gap 34 is formed between the sloped part 212 of the opening portion 21 and the sealing lip 9. When the valve unit 40 is fully opened, the pressure release gap 34 may be formed between the stem 6 and the sealing lip 9, as shown in, for example, FIG. 1B.

The first valve part 2 may also be called valve head. The valve head 2 is designed such that, in the first millimeter of travel when the valve unit 40 opens, only a small area is available for (or open for) the gas to flow. However, when the pressure increases, an increased flow area is opened to release gas. By this design, opening pressure tolerances between multiple venting units 40 is compensated. Therefore, multiple venting units 40 installed in the same battery pack will open at the same time.

In the valve assembly 10, the first valve part 2 closes the valve opening 8. The opening portion 21 of the first valve part 2 is located (or arranged) to close the valve opening 8 when the valve assembly 10 is in the closed state 101. As described above, the opening portion 21 has the sloped part 212 and, adjacent thereto and radially outside thereof, the planar part 211 (see, e.g., FIG. 1C). The sloped part 212 has a gradient that has its smallest value at the connection point between the sloped part 212 and the planar part 211. The planar part 211 seals the first valve part 2 towards the sealing lip 9 of the housing 1. In some embodiments, to improve the sealing, the planar part 211 includes a valve seal 213 (see, e.g., FIG. 1C), which contacts the sealing lip 9. Thereby, the sealing may become (or may become more) gastight. In some embodiments, the sealing may be watertight according to IPX7K or IPX9K standards. The first valve part 2 and the second valve part 4 have a longitudinal axis L, which extends through the center of the stem 6. The radial direction r is perpendicular to the longitudinal axis L and may be referred to when explaining aspects and features of the present disclosure. Even though the planar part 211 extends parallel to the valve opening 8, the planar part 211 is not limited thereto and may also be parallel to the longitudinal direction L or may be at an angle to the longitudinal direction L, that is, may have a tapered form or shape.

In FIGS. 1A and 1B, a guide rib 22 is shown. The guide rib 22 has a guide surface 23 (see, e.g., FIG. 1B), which is in contact with a radially inner portion of the sealing lip 9 (see, e.g., FIG. 1A). The guide surface 23 moves parallel to the longitudinal direction L. This guide surface 23 prevents the first valve part 2 from moving in the radial direction r. For example, the guide rib 22 is provided such that the guide rib 22 and the sealing lip 9 remain in close contact during the opening of the valve assembly 10. The width of the guide rib 22 may be equal to a wall thickness of the first valve part 2 or may be smaller or thicker than the wall thickness of the first valve part 2, for example, may be in a range between about 0.5 mm to about 3 mm. In some embodiments, the thickness may be in a range of about 1 mm to about 2 mm. In the illustrated embodiment, three guide ribs 22 are provided. However, the number of guide ribs is not limited thereto and may be any number between 1 to 5 or, in some embodiments, more than 5. The guide rib 22 may be formed integrally with the stem 6 and the first valve part 2. In other embodiments, the first valve part 2 and the second valve part 4 may be welded such that a weld seam 24 is formed therebetween. This weld seam 24 results from a welding process of the manufacturing method for producing the valve assembly, as will be described in more with reference to FIG. 7, below.

The first valve part 2 and the second valve part 4 are together movably arranged within the valve opening 8. The movement is restricted at (e.g., is limited to) two positions. First, in the closed state 101, the first valve part 2 is in direct contact with the sealing lip 9 of the housing 1, corresponding to a closed end position 32. The first valve part 2 is held in this state by the force of the spring 3. The face, which is located between the planar part 211 of the first valve part 2 and the sealing lip 9 in the closed state 101, is the plane of the valve opening p. When the first valve part 2 moves along the longitudinal axis L to its second restricted position, that is, when the spring 3 is compressed (or completely compressed), the planar part 211 is spaced apart from the plane of the valve opening p by a first valve part travel distance 33. This position corresponds to an opened end position 31. For example, the first valve part 2 moves between the closed end position 32 and the opened end position 31. In this regard, in FIG. 1B, the spring 3 is in a compressed state. The spring 3 is omitted in FIG. 1B to more clearly show the underlying structure. In FIG. 1B, the release gap 34 between the sealing lip 9 and the stem 6 is shown. The release gap 34 is formed everywhere in (or around) the valve opening 8 except for the location of the at least one guide rib 22. The length of the guide surface 23 may be equal to the first valve part travel distance 33. However, the length of the guide surface 23 is not limited thereto and may be shorter or longer than the first valve part travel distance 33. The length of the guide surface 23 is defined by the linear portion of the guide surface 23.

Referring to FIG. 1C, the sloped part 212 of the opening portion 21 will be described in more detail. Depending on the orientation of the venting unit 40, the description of the sloped part 212 differs. When the radial direction r is a vertical direction, the shape of the sloped part 212 in the cross-sectional view as shown in FIG. 1C may be described by the following equation:

$$y = f ( x ) = {x}^{z}$$

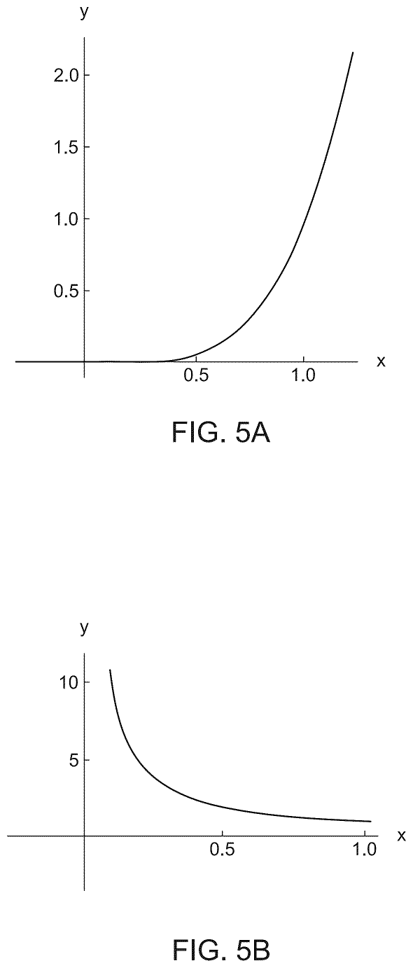

which is an exponential function, wherein z may be values >1 and x may be values ≥0. The origin of the graph is the contact point between planar part 211 and the sloped part 212. As would be apparent for the person skilled in the art, the larger the exponent z, the smaller the initial gradient for x values <<1 and the steeper the gradient for x-values >1. One example of a plotted exponential function describing the sloped part 212 of a venting unit 40 is shown in FIG. 5A. The function can be polynomial as well. However, in an alternative embodiment, if we assume that y=0 is the point of connection between the sloped part 212 and the stem 6 (e.g., the x-axis intersects the point of connection between the sloped part 212 and the stem 6), and x=0 is the point of connection between the sloped part 212 and the planar part 211 (e.g., the y axis intersects the point of connection between the sloped part 212 and the planar part 211), and the radial direction r is a horizontal direction, the shape of the sloped part 212 in the cross-sectional view as shown in FIG. 1C may be described by the following equation:

$$y = f ( x ) = \frac{1}{{x}^{z}}$$

as shown in FIG. 5B, with x values >0. As would be apparent for a person skilled in the art, the function may be altered by, for example, factors to achieve other suitable, similar shapes. As in FIG. 5A, the x-values may have an exponent “z”. The function can be polynomial as well.

Further, in some embodiments, the mathematical function may be R=x²+y², in which the plane shown in FIG. 1B is the x-y plane. For example, the sloped part 212 can be formed by a part of a circle, which is easy to be implemented. In such an embodiment, the gradient of the function in the x-direction would be 2x.

All of the described shapes are meant to be implemented in a rotationally symmetric manner around the longitudinal axis L and irrespective of the addition of any guide ribs 22. According to the shape of the sloped part 212, the size of the release gap 34 is controlled. For example, during opening of the valve assembly 10, the release gap 34 between the sealing lip 9 and the sloped part 212 increases. The maximum size of the release gap 34 is equal to the distance between the sealing lip 9 and the stem 6. The release gap 34 is a two-dimensional measurement but represents a ring-shaped gap between the sealing lip 9 and the sloped part 212. The area of the ring-shaped gap corresponds to the flow area, which will be discussed later.

FIG. 1D is a schematic cross-sectional side view of the venting unit 40 in the closed state. The descriptions of FIGS. 1A, 1B, and 1C apply to FIG. 1D and will not be repeated. FIG. 1D illustrates that a force path 105 goes from the housing 1 along the spring 3, to the second valve part 4, and through an ultrasonic welded connection 7 to the first valve part 2 back to the housing 1 via the sealing lip 9. The force path 105 is established by the spring force of the spring 3, which is in a pretensioned state after installation. For example, the force path 105 encloses the sealing lip 9 from two sides, for example, between the planar part 211 of the first valve part 2 at one side and one end of the spring 3 at the other side. For some applications, the spring 3 may not be installed in a pretensioned state. The depicted force path 105 allows for the valve opening 8 to be a void without any connections, such as webs for supporting the valve body. Thereby, air can flow freely through the valve opening 8. Further, tight sealing along the sealing lip 9 ensures the sealing performance of the venting unit 40. In some embodiments, the sealing lip 9 for contacting the planar part 211 of the first valve part 2 is elevated (or raised) with respect to its surrounding housing surface 14. Thereby, when a force acts on the sealing lip 9, its surface deforms less and, therefore, the sealing performance is increased.

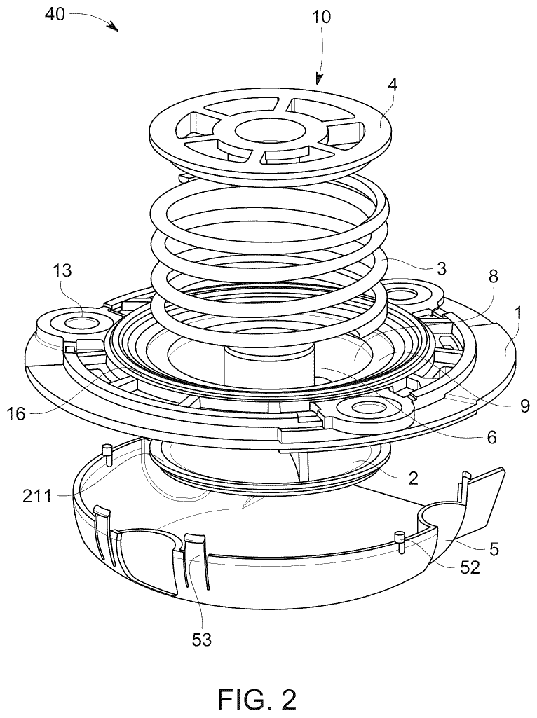

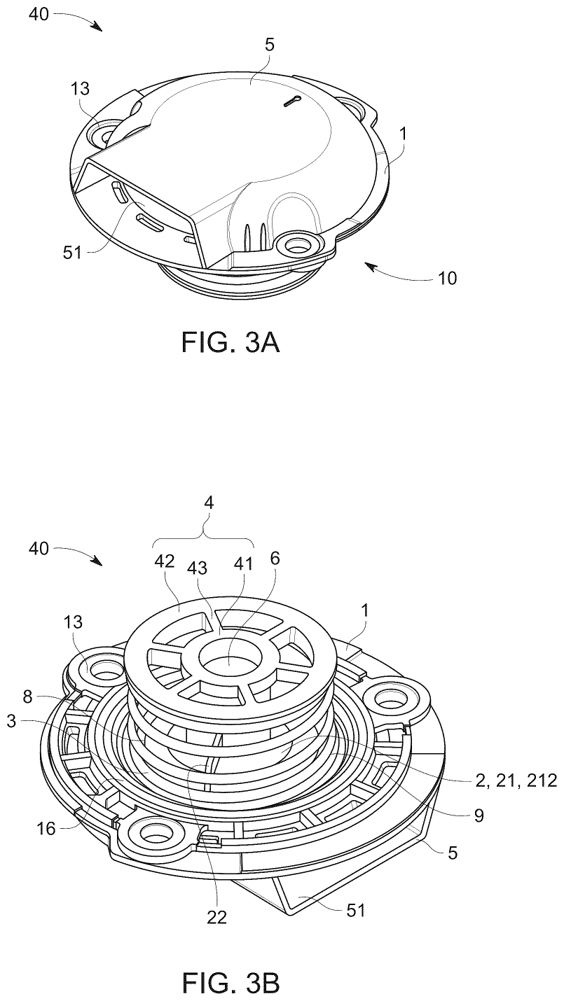

FIG. 2 illustrates an exploded view of the venting unit 40. The descriptions regarding FIGS. 1A to 2 apply accordingly. FIG. 3 also describes an assembly sequence of the venting unit 40 as will be described later with respect to FIG. 7. In the exploded view, it can be seen the first valve part 2 is integrally formed with the stem 6 and that the second valve part 4 is separate. Further, the sealing lip 9 forms a seat for the spring 3. For example, the spring 3 applies a force in the direction of the sealing lip 9, and the planar part 211 of the first valve part 2 also applies a force in the direction of the sealing lip 9 so that the sealing lip 9 is sandwiched between the planar part 211 and the spring 3. Thereby, the sealing performance is improved. Compared to the assembled views shown in FIGS. 1A-1D, positioning components, such as pins 52, and fixing components, such as hooks 53 on the cover cap 5 are shown, which securely position and fix the cover cap 5 to the housing 1. However, such positioning components or fixing components may be omitted, and the cover cap 5, if present, can be connected differently to the valve assembly 10.

TABLE 1
Components of the Venting Unit 40 Shown in FIG. 2

| Ref No. | PART NAME | MATERIAL |
|---|---|---|
| 1 | Housing | Plastic (PP, TPE)/Carbon steel (1215) |
| 2 | Frist valve part | Plastic (PP, TPE) |
| 3 | Spring | Stainless steel (301) |
| 4 | Second valve part | Plastic (PP) |
| 5 | Cover cap | Plastic (PP) |

Table 1 shows components and the materials of the venting unit 40 as shown in FIG. 2, that is, of the housing 1, the first valve part 2, the spring 3, the second valve part 4, and the cover cap (or protection cover) 5 according to an embodiment of the present disclosure.

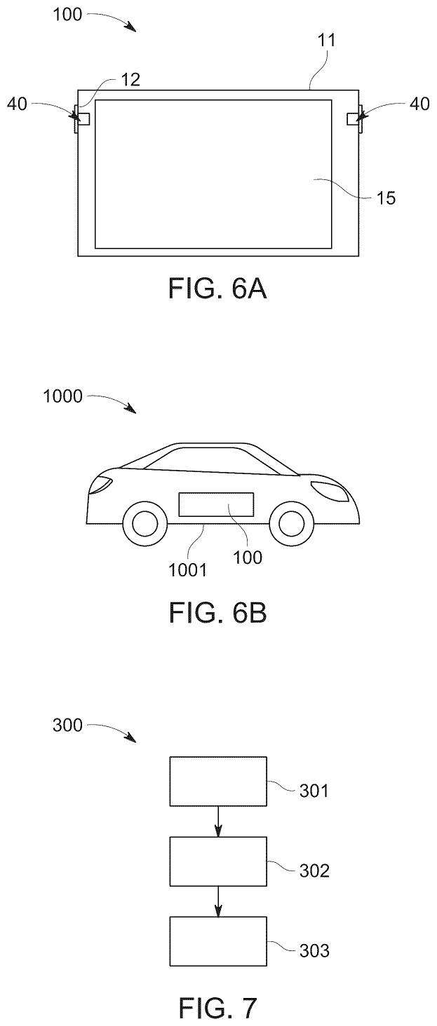

FIG. 3A is a schematic perspective view of an exterior of the venting unit 40 according to an embodiment in an assembled state. The venting unit 40 may include the cover cap 5 on top of the valve assembly 10, as described above. The cover cap (also called protection cover) 5 is designed such that dust and moisture (e.g., ice) would need to move or climb upwardly along a channel to enter the venting unit 40. Due to gravity, dust and moisture generally move downwardly and move upwardly only a small distance. To prevent the above-mentioned negative effects, when the venting unit 40 is installed in a battery pack 100 (see, e.g., FIG. 6A), a cover cap opening 51 in the cover cap 5 may face in the direction of gravity. However, due to design requirements, the cover cap opening 51 may face in a direction angled with respect to the direction of gravity. Further, the venting unit 40 has mounting openings 13 provided in the housing 1. In the illustrated embodiment, three mounting openings 13 are visible. However, any suitable amount of mounting openings 13, for example, 2, 4, or 5 are possible. In the illustrated embodiment, the mounting openings 13 are holes, through which fixing devices, such as screws, may pass through. In other embodiments, the mounting openings 13 may instead be pins, integrally formed anchors, or any other suitable fixing components. The connecting components are connected to a battery casing 11 (see, e.g., FIG. 6A) so that the venting unit 40 is mounted to a respective venting hole 12 (see, e.g., FIG. 6A) formed in the battery casing 11.

FIG. 3B is a schematic inside perspective view of the assembled venting unit 40. The descriptions regarding all previous figures apply, unless stated otherwise. FIG. 3B shows the same venting unit as shown in FIG. 3A rotated by about 180° so that the bottom side, rather than the upper side, is visible. According to the illustrated embodiment, the venting unit 40 includes the spring 3 (e.g., on the inside of the battery pack 100), the cover cap 5 (e.g., a dust and moisture protection cap), and the valve design having improved opening behavior. The valve, that is, the valve assembly 10, further includes the first valve part 2 configured to open and close the valve opening 8 and the stem 6 being connected to the first valve part 2 on one of its ends. The opposing end of the stem 6 is provided with a second valve part 4. The spring 3 extends along the stem 6 between the housing 1 and the second valve part 4. The second valve part 4 may have an inner circle 41 connected to the stem 6, an outer circle 42 for holding the spring 3, and webs or ribs 43 for connecting the inner circle 41 to the outer circle 42. However, the second valve part 4 may also have a different shape, such as a disk-shape. Further, the stem 6 and the spring 3 extend perpendicular to the first valve part 2 and the second valve part 4. Additionally, although the stem 6 is illustrated as being hollow in the illustrated embodiment, the present disclosure is not limited thereto. The first valve part 2 is further provided with three guide ribs 22 on its inner surface portion. The first valve part 2 is held in the center of the spring 3 by the guide ribs 22, or in other words, is held in the center of the valve opening 8. In some embodiments, the second valve part 4 and the stem 6 may be omitted when the first valve part 2 is directly provided with holding components, such as clips, for supporting the spring 3. Such holding components may be provided on the guide rib 22. The opposite side of the spring 3 is supported on the downside (or bottom side) of the sealing lip 9 of the housing 1. Radially outside and distanced from the sealing lip 9, a housing seal 16 may be provided. All parts enclosed by the housing seal 16 are located on the inside of a battery pack (see, e.g., FIG. 6A) when the venting unit 40 is mounted to the battery pack. The housing seal 16 seals the venting hole 12 (see, e.g., FIG. 6A) to the housing 1 so that the opening and closing of the venting hole 12 is controlled by the venting unit 40.

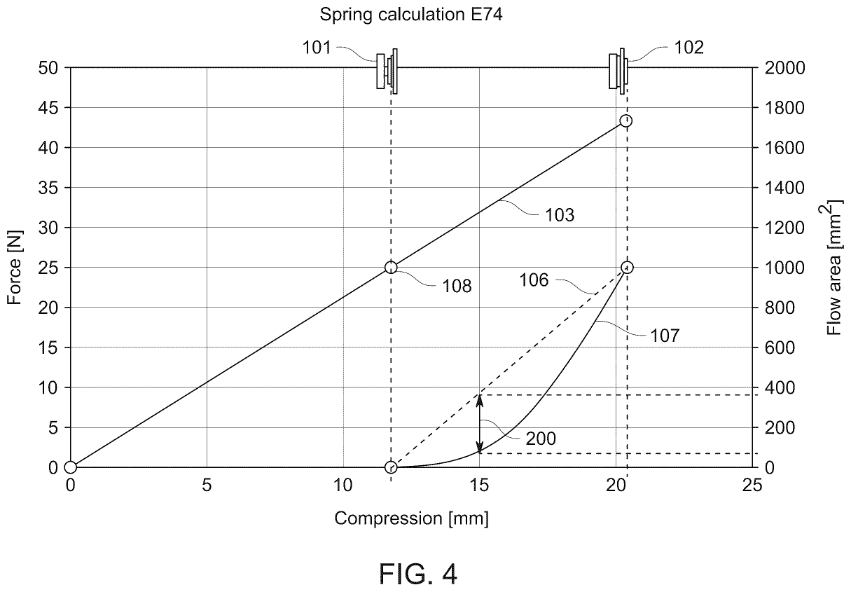

FIG. 4 is a graph describing the flow area in relation to compression of the spring 3 of the venting unit 40. FIG. 4 shows a comparison between a conventional venting unit (labeled “conventional design” and illustrated with a dotted line) and the above-described venting unit 40 according to an embodiment of the present disclosure (labeled as “optimized design” and illustrated by a solid line). The vertical axis on the left shows the force applied to the spring 3, and the horizontal axis shows the compression of the spring 3. The solid line labeled 103 depicts the spring force. When no force is applied, the compression of the spring 3 is zero. Therefore, the graph of the spring force 103 starts at the point of origin. Further, the spring 3 is installed in a pretensioned state, which can be seen by the vertical dotted line starting from the symbol indicating the closed state 101. When a force that is greater than the pretension force 108 acts on the first valve part 2, the spring is compressed and the first valve part 2 moves along its longitudinal axis L away from the housing 1. In the open state 102, when the valve assembly reaches its opened end position 31, the spring 3 is compressed to its maximum state and a further increase in force does not result in further movement of the first valve part 2. This state is indicated by the vertical dotted line starting from the symbol indicating the open state 102. For conventional venting units of battery packs, the linear compression of a spring results in a linear movement of a valve body and, consequently, a linear increase in flow area. The flow area is illustrated on the second vertical axis on the right. Flow area refers to the area of the opening which the venting assembly opens so that gas can flow from the pressure side, where the force acts on, to the other side. This linear increase in flow area is shown by the dotted line representing a conventional design 106. With the optimized design 107 (shown as the solid line), a non-linear increase in flow area is provided. For better comparison, the graph shows that the starting point and the end point of the conventional design 106 and the optimized design 107 are identical. The difference lies in the slower initial increase in flow area and the sharper increase in flow rate at larger opening positions. For example, as shown at a compression of about 15 mm of the spring 3, the flow area is shifted from about 380 mm² down to about 100 mm² for the same spring 3. That is, a flow area shift 200 is introduced. This flow area graph of the optimized design 107 is defined by the shape of the sloped part 212. The flow area is proportional to the release gap 34 between the sealing lip 9 and the sloped part 212. Embodiments for the shape of the sloped part 212 are shown in FIGS. 6A and 6B, as already described above. In another embodiment, additionally or alternatively to the sloped part 212, a progressive spring may be used. A progressive spring has a non-linear characteristic spring force curve, compared to the linear characteristic spring force curve of a linear spring (cf. spring force 103) so that the flow area may be adjusted similarly.

FIG. 5A shows a plotted function illustrating a first example of a shape of a sloped part 212 of the venting unit 40, and FIG. 5B shows another plotted function illustrating the shape of a second sloped part 212 of a venting unit 40 as described above. These functions are merely examples of shapes for the sloped part 212 and depend on which element of the venting unit 40 is associated with the origin of the graphs. The shape is not limited thereto and may be a free-hand shape not following any function or may follow a different function resulting into a similar shape.

FIG. 6A is a schematic cross-sectional side view of a battery pack 100 including a venting unit 40 as described above. The battery pack 100 houses one or more battery cells 15 within a battery casing 11. In the illustrated embodiment, the battery casing 11 has two venting holes 12 and two venting units 40 mounted respectively thereto. Accordingly, the spring 3 of the venting unit 40 can be provided inside the battery casing 11 such that a pressure rise inside the battery casing 11 can be directly applied to the valve assembly 10. However, the battery pack 100 is not limited thereto and may have any other suitable configuration with further venting units 40 or only one venting unit 40. The venting units 40 are installed to side walls of the battery casing 11. In this configuration, the cover cap 5, if present, can be provided such that the cover cap opening faces downwards opposite to the direction of gravity. As a consequence, dust or dirt can be efficiently hindered from entering the venting unit. Further, the spring 3 of the venting unit 40 is oriented perpendicular to the direction of gravity and the spring 3 acts independently of gravity. However, they may also be installed to the top or bottom wall of the battery casing 11. In one embodiment, each wall has at least one venting unit 40 so that the pressure can be uniformly released. In another embodiment, the venting unit 40 is installed on all but one wall. In another embodiment, there may be two or more venting units 40 per wall.

FIG. 6B is a schematic cross-sectional side view of an electric vehicle 1000 including a battery pack 100. The electric vehicle is not limited to one battery pack 100 and may include a plurality of battery packs 100. Further, even though venting units 40 are not visible here, the cover cap openings 51 point into the direction of gravity, that is, to the underside 1001 of the electric vehicle 1000.

FIG. 7 is a flow chart describing a method 300 for assembling a venting unit 40 according to an embodiment of the present disclosure. In a first step 301, the housing 1 of the venting unit 40 is placed together with the first valve part 2 into an ultrasonic tool fixture. For example, in the first step 301, the first valve part 2 is placed onto the ultrasonic tool fixture with the stem 6 facing away from the ultrasonic tool fixture. Thereafter, the housing 1 is placed on top of the first valve part 2 such that the stem 6 protrudes through the valve opening 8. In a second step 302, the spring 3 is placed on the housing 1 opposite to the first valve part 2. For example, the spring 3 is on the upper side of the first valve part 2 and of the housing 1. Then, the second valve part 4 is placed onto the spring 3. In a third step 303, a second ultrasonic tool is applied from the top to compress the spring 3 together and, through vibration, the first valve part 2 and the second valve part 4 are welded together, for example, by ultrasonic welding. The welding results in a weld seam 24 as shown in, for example, FIG. 1C. The arrangement of parts is shown in FIGS. 3A and 3B except that the cover cap 5 is not present during welding and that the first and second ultrasonic tool are not shown. However, the present disclosure is not limited to this construction, and the stem 6 may be integrally formed with the second valve part 4 so that a weld seam 24 is formed between the first valve part 2 and the second valve part 4 next to the opening portion 21. In another embodiment, the first valve part 2 and the second valve part 4 may be connected by a chemical connection, such as by glue, or a mechanical connection, such as by hooks 53 and latches.

SOME REFERENCE SIGNS

| 1 | housing | 2 | first valve part |
|---|---|---|---|
| 21 | opening portion | 211 | planar part |
| 212 | sloped part | 213 | valve seal |
| 22 | guide rib | 23 | guide surface |
| 24 | weld seam | 3 | spring |
| 4 | second valve part | 41 | inner circle |
| 42 | outer circle | 43 | webs |
| 5 | cover cap | 51 | cover cap opening |
| 52 | pin | 53 | hook |
| 6 | stem | 7 | ultrasonic welded connection |
| 8 | valve opening | 9 | sealing lip |
| 10 | valve assembly | 11 | battery casing |
| 12 | venting hole | 13 | mounting means |
| 14 | housing surface | 15 | battery cells |
| 16 | housing seal | 31 | opened end position |
| 32 | closed end position | 33 | first valve part travel distance |
| 34 | release gap | 40 | venting unit |
| 100 | battery pack | 101 | closed state |
| 102 | open state | 103 | spring force |
| 105 | force path | 106 | conventional design |
| 107 | optimized design | 108 | pretension force |
| 200 | flow area shift | | |
| 300 | method for assembling venting unit | | |
| 301 | placing first parts onto first ultrasonic tool fixture | | |
| 302 | placing second parts | | |
| 303 | applying second ultrasonic tool fixture to send part | | |
| 1000 | electric vehicle | 1001 | underside |
| L | longitudinal axis | R | radial direction |
| P | plane of the valve opening | | |

What is claimed is:

1. A venting unit for a battery pack, the venting unit comprising:
a valve assembly comprising:
a housing having a valve opening and a sealing lip extending around the valve opening;
a first valve part configured to open and close the valve opening;
a second valve part;
a stem, one end of the stem connected to the first valve part, an opposing end of the stem connected to the second valve part; and
a spring extending along the stem between the housing and the second valve part,
wherein the first valve part has an opening portion with a planar part and a sloped part connected, at one side, to the planar part and, on an opposing side, connected to the stem,
wherein a gradient of the sloped part increases from the planar part toward the stem,
wherein, in a closed state of the valve assembly, the planar part of the opening portion and the sealing lip of the housing are on top of each other to seal a gap between the opening portion and the housing, and
wherein, in an open state of the valve assembly, the opening portion is spaced apart from the sealing lip against the force of the spring such that a release gap is formed between the sloped part of the opening portion and the sealing lip.

2. The venting unit as claimed in claim 1, wherein the venting unit further comprises a cover cap covering the valve assembly,
wherein the cover cap has a cover cap opening.

3. The venting unit as claimed in claim 1, wherein the stem and the spring extend perpendicular to the first valve part and the second valve part.

4. The venting unit as claimed in claim 1, wherein the first valve part has a guide rib on an inner surface portion of the first valve part.

5. The venting unit as claimed in claim 4, wherein the guide rib and the sealing lip remain in contact during opening of the valve assembly.

6. The venting unit as claimed in claim 1, wherein the gradient of the sloped part has a smallest value at a connection point between the sloped part and the planar part.

7. The venting unit as claimed in claim 1, wherein the first valve part is movable along a longitudinal direction of the stem between an opened end position and a closed end position.

8. The venting unit as claimed in claim 1, wherein, during opening of the valve assembly, the release gap between the sealing lip and the sloped part increases, and
wherein a maximum size of the release gap is equal to a distance between the sealing lip and the stem.

9. The venting unit as claimed in claim 1, wherein the spring is in a pretensioned state in the closed state of the valve assembly.

10. The venting unit as claimed in claim 1, wherein the stem is hollow.

11. The venting unit as claimed in claim 1, wherein the sealing lip is raised with respect to its surrounding housing surface.

12. A battery pack comprising:
a plurality of battery cells accommodated within a battery casing; and
the venting unit as claimed in claim 1 mounted to a venting hole in the battery casing.

13. The battery pack as claimed in claim 12, wherein the first valve part has a guide rib on an inner surface portion of the first valve part, and
wherein the guide rib has a guide surface configured to move parallel to a longitudinal direction of the stem.

14. The battery pack as claimed in claim 12, wherein the venting unit further comprises a cover cap covering the valve assembly,
wherein the cover cap has a cover cap opening, and
wherein the cover cap opening points in the direction of gravity.

15. An electric vehicle comprising the battery pack as claimed in claim 12.
